(19) United States
(12) Patent Application Publication
(10) Pub. No.: US 2007/0272622 A1
(43) Pub. Date: Nov. 29, 2007

(54) SANITIZING METHODS AND SYSTEMS

(76) Inventors: Richard D. Mercer, Spring, TX (US); Timothy M. Mercer, Spring, TX (US)

Correspondence Address: KENNETH L. NASH, P.O. BOX 680106, HOUSTON, TX, 77268-0106, US

(21) Appl. No.: 11/752,623

(22) Filed: May 23, 2007

Related U.S. Application Data
(60) Provisional application No. 60/890,870, filed on Feb. 21, 2007.
(60) Provisional application No. 60/867,842, filed on Nov. 30, 2006.
(60) Provisional application No. 60/842,882, filed on Sep. 7, 2006.
(60) Provisional application No. 60/830,287, filed on Jul. 12, 2006.
(60) Provisional application No. 60/803,143, filed on May 25, 2006.

(51) Int. Cl. C02F 1/76

(52) U.S. Cl. 210/754

(57) ABSTRACT

Salt and potassium compound may be reacted in a swimming pool or other body of water to be sanitized and/or cell plates may be utilized. NaCl may also be added to the mix to produce a shock formulation. The swimming pool or other water may already contain salt brine with sufficient concentration of salt. The delivery method of KHSO₅ may include broadcasting, dispensing, or other means. In fresh water pools the salt may also be added for this purpose, such as within a canister or other vessel, wherein a local reaction products of the cell plate and/or potassium compound may be dispensed to create a desired chlorine level in the water for sanitizing. For sanitizing with metal ions, the potassium compound and salt and/or cell plates may be utilized to create a reaction with elemental transitional metals and/or alloys thereof.

The present application claims benefit of U.S. Provisional Application 60/890,870 filed Feb. 21, 2007, U.S. Provisional Application 60/867,842 filed Nov. 30, 2006, U.S. Provisional Application 60/842,882 filed Sep. 7, 2006, U.S. Provisional Application 60/830,287 filed Jul. 12, 2006, and U.S. Provisional Application 60/803,143 filed May 25, 2006.

### BACKGROUND OF THE INVENTION

1. Field of the Invention

The present invention relates generally to sanitizing bodies of water, and is especially adapted for sanitizing salt water or fresh water swimming pools, plumbing, pipes, and the like.

2. Description of the Background

Chlorine, shock, bleach, and the like, are commonly used to sanitize swimming pools, bathroom fixtures, and so forth. However, such chemicals are hazardous and expensive. It would be desirable to provide non-hazardous and relatively inexpensive methods and devices to provide these functions. For instance, present day systems may easily cost in the range of $1.00 to $2.00 per day or more for sanitizing a relatively small, private swimming pool. In accord with various embodiments of the present invention, the cost may be reduced to as little as a few cents per day. Various embodiments of the present invention may also be utilized for greatly reducing costs of sanitizing public pools, such as those found at theme parks, or the like.

U.S. Pat. No. 6,824,794 B2 utilizes copper sulfate pentahydrate and silver oxide in combination with KHSO₅ for the purpose of slow release copper and silver ions to inhibit, reduce, or prevent the formation of algae and bacteria in a water body. A less expensive method or means of generating such copper and silver ions from transitional or elemental metallic state using salts is not shown.

Those of skill in the art will appreciate the present invention that addresses the above needs and other significant needs, the solution to which are discussed hereinafter.

### SUMMARY OF THE INVENTION

An object of the present invention is to provide improved methods for sanitizing either salt or fresh water.

Another object of the present invention is to provide improved methods for sanitizing swimming pools, toiletries, pipes, and the like.

These and other objects, features, and advantages of the present invention will become apparent from the drawings, the descriptions given herein, and the appended claims. However, it will be understood that the above-listed objectives and/or advantages of the invention are intended only as an aid in quickly understanding aspects of the invention, are not intended to limit the invention in any way, and therefore do not form a comprehensive or restrictive list of objectives, and/or features, and/or advantages.

Accordingly, in one embodiment a method is provided for sanitizing swimming pools, pipes, plumbing, toiletries, wastewater, drinking water, and the like. The method may comprise reacting potassium or potassium based compounds with salt in an aqueous solution to produce HOCL for use in sanitizing swimming pools, pipes, plumbing, toiletries, waste water, drinking water, and the like, e.g. the potassium compounds+salt+H₂O react to produce chlorine in a suitable form for sanitizing purposes. In one embodiment, sufficient potassium or potassium based compounds such as KHSO₅ may be utilized at one time with salt such as NaCl and water to reach breakpoint chlorination levels. In one possible embodiment, KHSO₅ might be broadcast into a pool or spa such as by hand, bucket, or the like. The method may comprise utilizing KHSO₅ to at least achieve and/or maintain typical chlorine levels of between about 0.5 ppm to 3.0 ppm chlorine in a swimming pool or spa. The method may also comprise using sufficient quantities at one time to achieve breakpoint chlorination levels. In one embodiment, KHSO₅ is packaged in amounts sized to pool or spa sizes, e.g., 10K gallons, for maintaining chlorine levels and/or for achieving breakpoint chlorination levels. KHSO₅ and/or NaCL and/or elemental metals may be broadcast, reacted in a pool or spa or the like, reacted in a container, canister, or the like that dispenses chlorine or HOCL into a pool, spa, flow line, circulation stream, or the like.

### BRIEF DESCRIPTION OF THE DRAWINGS

Various other objects, features and attendant advantages of the present invention will become fully appreciated as the same becomes better understood when considered in conjunction with the accompanying drawings, and wherein:

FIG. 1 is an elevational view, in section, showing one possible embodiment of a device that may be utilized for sanitizing a non-salt pool (or pool with a relatively low concentration salt brine) in accord with the present invention; and

FIG. 2 is an elevational view, in section, showing another possible embodiment of a device that may be utilized for sanitizing a salt water pool in accord with the present invention.

FIG. 3 is an elevational view, in section, showing one possible embodiment of a commercial system with a holding tank for use in providing a sanitizing solution to a commercial pool as needed.

FIG. 4 is a top view of one possible embodiment of the system of FIG. 4.

FIG. 5 is a view of a transitional metal, such as copper, which in one embodiment may be reacted to produce ions utilizing a hydrogen bubble induced flow coming from electrically charged plates, or in another embodiment reacted with KHSO₅ and NaCl to produce Cu and Cu₂, in accord with the present invention.

FIG. 6A is an elevational view, in section, of one possible embodiment of a floating canister or vessel wherein KHSO₅+NaCl+H₂O+elemental metal(s) may be used to produce HOCL and elemental metal ions for distribution into a pool.

FIG. 6B is an elevational view, in section, showing filling of the embodiment of FIG. 6A with KHSO₅ or KHSO₅+NaCl or KHSO₅+NaCl+elemental metal(s).

FIG. 7 is an elevational view, in section, of one possible embodiment of an inline canister or vessel wherein KHSO₅+NaCl+H₂O+elemental metal(s) for distribution into a pipe that may or may not lead to a swimming pool.

FIG. 8 is an elevational view, in section, of one possible embodiment of a floating canister or vessel wherein KHSO₅+NaCl+H₂O+elemental metal(s) may be used to produce HOCL and elemental metal ions for distribution into a pool.

FIG. 9A is a top view showing a KHSO5 sump canister or vessel and valve arrangement.

FIG. 9B is an enlarged view of a valve arrangement for a sump canister or vessel for a pool or spa to dispense chlorine and/or ions that contains KHSO₅ and/or NaCL and/or metallic ion materials such as copper or silver.

FIG. 9C is a side view showing a KHSO₅ sump canister or vessel and valve arrangement.

FIG. 10 is an elevational view showing a canister or vessel for use in a spa.

FIG. 11 is an elevational view showing a canister or vessel mountable within a sump basket.

While the present invention will be described in connection with presently preferred embodiments, it will be understood that it is not intended to limit the invention to those embodiments. On the contrary, it is intended to cover all alternatives, modifications, and equivalents included within the spirit of the invention and as defined in the appended claims.

### DESCRIPTION OF PRESENTLY PREFERRED EMBODIMENTS

An advantage of the present invention is a much less expensive method of sanitizing water that is also much safer than commonly used alternatives. In accord with embodiments of the present invention, the cost of sanitizing pools may be reduced by a factor of 100. The present invention may be utilized for inexpensively and safely cleaning plumbing, toiletries, etc.

In one possible embodiment of the invention, Potassium Monopersulfate (KHSO₅, KHSO4, KHSO3) compound is used as discussed below, and provides for powerful, effective and inexpensive production of chlorine and/or elemental metal ions in a wide variety of industrial and consumer uses, without need of expensive chlorine tablets or other expensive sanitizing chemicals. The treatment process with KHSO₅ meets the requirements of the safety and environmental protection agencies. However, the cost for sanitation may be a small fraction of present day costs of providing chlorine and/or elemental metal ions for sanitizing.

When KHSO₅ is mixed with NaCL and H₂O, the CL molecule is displaced or released and combined with a water molecule to formulate HOCL. This reaction also displaces the Hydrogen (H) molecule and other gasses when mixed in concentration, which expels or gasses off, creating a dispersing effect. In another embodiment, the present invention may utilize hydrogen and other gasses for producing pressure to inject the CL and/or elemental metal ions into the water to be sanitized. KHSO₅ may be broadcast or otherwise delivered into saltwater pools with sufficient salt to sanitize pools by chlorinating them and/or by shocking the pools.

This process and method of generating chlorine from either cell plates and salt and water and/or potassium compounds, salt and water would alleviate the consumer from purchasing and installing an energy consuming chlorine generator and/or purchasing expensive corrosive chlorine tablets.

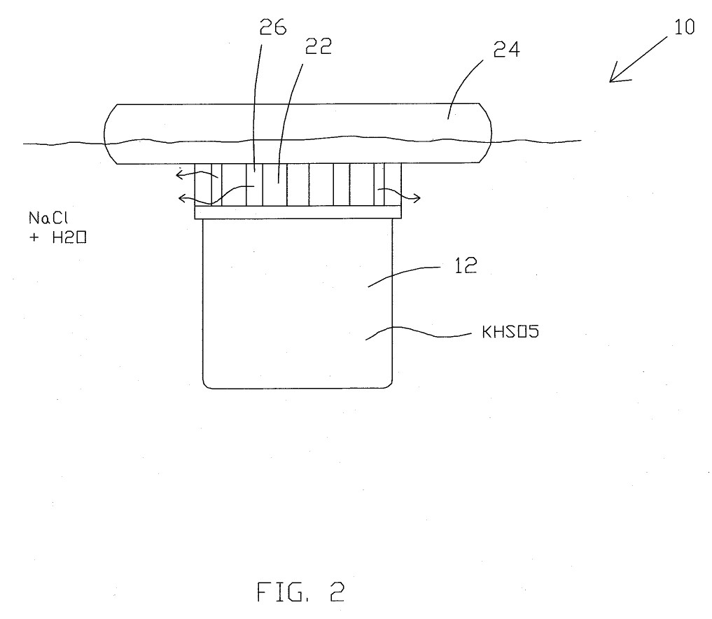

Many swimming pools utilize a relatively high concentration salt brine and may be referred to as salt water pools. In accord with one possible embodiment of the present invention, the chlorine in this salt may be released utilizing relatively inexpensive and low cost chemicals that contain potassium. For instance, adding potassium Monopersulfate (KHSO₅) releases the chlorine molecule and formulates HOCL for the purpose of sanitation. FIG. 2 shows a floating device that might be used in a swimming pool or water source for this purpose in accord with the present invention.

While floatation devices are shown, other means for feeding the chemicals or gasses, such as connections to a recirculation pipe or other pipe, may be used wherein the chemicals or gasses feed into the pipe.

Many examples of various devices for feeding chemicals or the reaction results into a pool or pipes or the like are shown in my other patent applications and patents, which are hereby incorporated herein by reference.

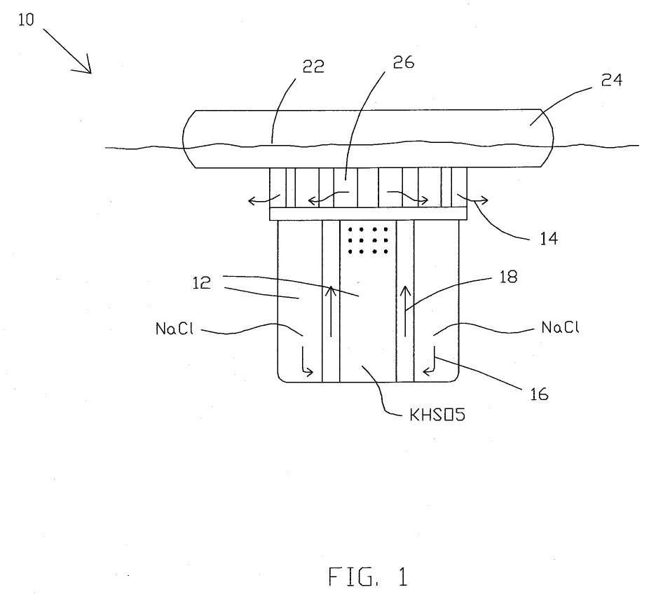

For other swimming pools, which might be referred to as non-salt pools, which may have from no salt to a relatively low concentration salt brine, the present invention may also be used. In this case, the HOCL may be produced by providing the reaction in a smaller container and then introducing the results into a swimming pool. As shown in FIG. 1, a canister or vessel 10, which may float in the swimming pool, may contain one or more compartment(s) 12, which may preferably be utilized to store both salt and a potassium compound, as indicated.

### In this embodiment, a float 24 is utilized however the canister or vessel could be mounted differently and a few possible examples are provided hereinafter.

In this embodiment, the reaction produces what may be a continuous flow through the canister or vessel as shown by arrows 14, 16 and 18 thereby introducing the chlorine into the pool in a useful form. In this embodiment, the water may flow through openings 26 into one or more compartments 12, which contain potassium compound. Salt may also be provided in compartments 12 or be present in the swimming pool water as indicated in FIG. 2. Flow of the water proceeds as indicated by 16 whereupon the reaction products, such as hydrogen, induce flow upwardly as indicated by arrow 18 and back out into the pool as indicated by arrow 14. The canister or vessel provides for introduction of chlorine by slowly dissolving salt (NaCL) and potassium Monopersulfate (KHSO₅) in a canister or vessel for slow release and constant chlorination.

In one embodiment, the present method involves alkali metal compounds, preferably potassium monopersulfate, but is not restricted thereto, and alkali metal salts, preferably NaCL, but is not restricted thereto, and H₂O.

In addition or separately, the present method may also provide enhanced sanitation and/or anti-algae functions utilizing elemental metal ions in at least one of compartment(s) 12, preferably Cu, Cu₂, Ag, but is not restricted thereto. Alloys, such as alloys containing element Cu and Ag, may also be utilized. This is accomplished by the introduction of elemental transitional metals and the reaction thereof, for the purpose of sanitation, purification, and prevention of algae formation and bacteria growth in a body of water.

In one embodiment, the invention may comprise a composition of active oxygen compounds, alkali metal salts and H₂O and transitional metals in which oxidation reduction occurs and the reaction of polyatomic bonding occurs to produce copper sulfate pentahydrate (CuSO₄-5H₂O), copper sulfate (CuSO₄), copper(2) sulfate (Cu₂SO₄), silver oxide (Ag₂O) and zinc oxide (ZNo), and the like. The addition of salt, NaCl, to the composition furthermore invokes an electrolytic response from the metallic ions and maintains a charged ion that is more effective in neutralizing bacteria and algae growth than the dormant version thereof, whether the salt be part of the composition or introduced in the water to be treated. Thus, the present invention may take advantage of the salt content of salt water pools, e.g. pools wherein the salt brine may be greater than about 350 to 500 ppm and might be much more concentrated such as up to 10,000 ppm. However, the present invention may also be utilized in pools with a salt brine of less than 350 ppm, as discussed herein.

Therefore, one possible embodiment of the present invention may be utilized to produce CuSO₄-5H₂O, Cu₂SO₄, CuSO₄, Ag₂O, ZnO, and the like. from the elemental state of transitional metals such as copper and silver, and by the reactive process of KHSO₅ plus H₂O plus NaCL, in which oxidation reduction occurs and polyatomic bonding and transformation occur.

The method of conversion and output of the transitional metals can be controlled by the amounts of transitional metals that are added to the alkali metal compound, or are subject to the reactive process either in anode form or elemental.

The method of conversion can also be controlled by the amount of salts that are added to the composition of alkali metals and transitional metals plus H₂O, whether the salts be in the initial composition or present in the water as a brine solution.

The method of conversion can further be controlled by the amount of H₂O that is allowed into said composition and can be regulated by that means or by the means of restriction. While various types of adjustable openings may be provided, rotatably adjustable slotted members 22 may be used to control the size of openings 26. FIG. 2 shows that the slotted members 22 have been rotated to reduce the size of openings 26. The slotted members may comprise two tubular members with slots therein that when mesh are fully open and otherwise can be moved to a closed position. Other fixed or variable restrictions might also be provided to further control flow of input water as indicated by flow arrow 16.

The use of the present invention is not limited to canister or vessel 10. Output of CuSO₄-5H₂O, Ag₂O, ZnO, and the like into a body of water to be treated can be regulated as aforementioned, and can be utilized in tablet form, liquid or powder, and introduced into said body of water either in a floater, injected, venturi method, inline canister, circulation, or by reactive introduction whereby H₂ and other gasses are produced and can be utilized to distribute said composition either by pressure buildup or venturi draw.

The method of conversion of transitional metals can be controlled and regulated by the amount of water to be treated, EPA regulations and guidelines, the amount of salt in the water in ppm as compared to the volume of water, and the quantity addition of transitional metals as compared to each other and the reaction thereof.

A constant and adjustable method of generating HOCL (hypochlorous acid) from salt water would be the slow introduction of KHSO₅ either in-line, or via floater, or pill form, or tablet form, or slow release form, or otherwise such as with canister or vessel 10 (see FIG. 1 and FIG. 2). Other reactive potassium compounds, such as oxymonopersulfate, K₂HSO₅, K₂HSO₄, and/or K₂HSO₃ activate chlorine from salt water and release chlorine or HOCL, and can be utilized as a method of constant sanitization for a safe swimming environment. Salt water levels can range from 350 parts per million to 10,000 parts per million and proportionate amounts of potassium based compounds would vary by NaCL level in the water.

As another example, for cleaning smaller volumes of water, 1 teaspoon of NaCL and 1 teaspoon of KHSO₅ will produce over 30 parts per million of chlorine (HOCL) in 1 gallon of water. This can further be expanded on as use as a bleaching agent by adding 2 grams of potassium monopersulfate with 2 grams of salt to a cup of water.

In another embodiment, CuSO₄-5H₂O and other oxides are produced by reaction with the mixture of KHSO₅+H₂O+NaCL, and/or with the addition of oxymonopersulfate, elemental copper, silver, Zinc, Mg, and/or the like, wherein the reaction or oxidation effect occurs in the soup. The salt brine effect on KHSO₅ releases CL₂ and Cu₂ from the anode, which becomes electrolytic in the brine, or non-staining under 1.3 ppm. Silver will oxidize, as well as zinc and magnesium, in the KHSO₅ and brine due to the cation transference of ions, and will also become electrolytic ions.

As another embodiment for cleaning algae from ponds, pipes, and the like, potassium Monopersulfate and salt may be applied in equal quantities, into an algae environment in which the algae is eradicated from the water. For a swimming pool, for instance, introduce 2 lb. NaCL/2 lb. K based compound to a 10,000 gallon pool.

While Potassium Monopersulfate (KHSO₅) is provided as an example, it will be appreciated that other potassium compounds may also be utilized. For instance, a non-comprehensive list of potassium compounds might include Potassium Persulfate (K₂S₂O₈), Potassium Monopersulfate Sate (KH SO₄), Potassium Peroxymonopersulfate (K₂SO₄), and/or alloys involving potassium.

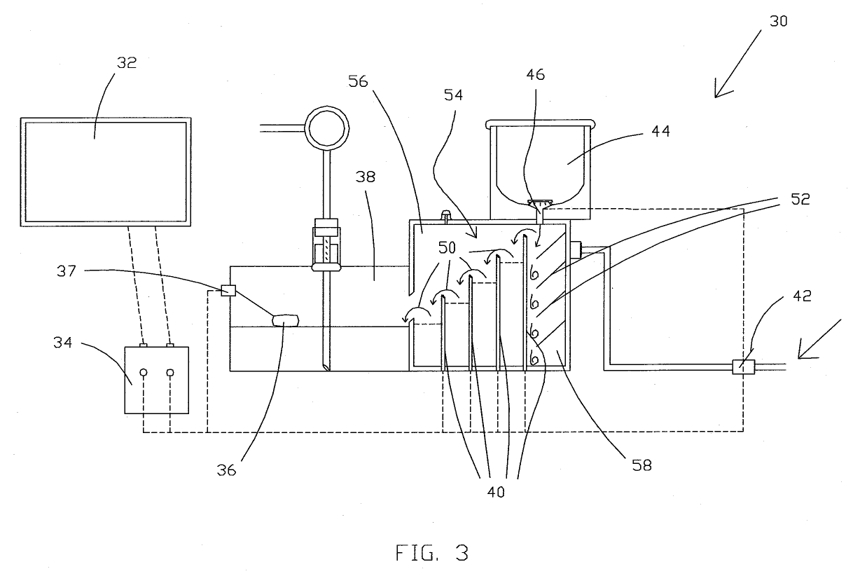

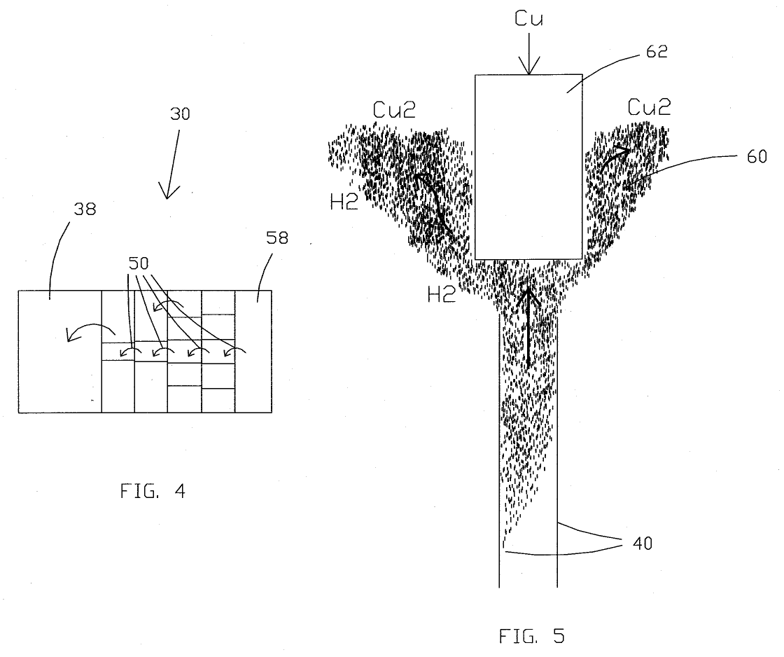

The present invention may be used to sanitize commercial pools such as theme park swimming pools, such as by using the commercial system shown in FIG. 3 and FIG. 4. The embodiments may or may not comprise use of electricity and cell plates acting in salt water with or without potassium compounds such as KHSO₅ discussed above.

Commercial sanitizing system 30, as shown in FIG. 3, may be operated by solar power panel 32 that charges battery 34. Battery 34 or other power such as house power may be used to control float 36 in the holding chamber 38, the cell plates 40, an inlet valve 42 for water to fill the holding chamber, and salt hopper valve 46 for a salt hopper 44.

In this embodiment, mixing chamber 48 has a water flow path as indicated by arrows 50 that preferably utilizes baffles 52 and variable length barriers to create water cascades 54 leading to holding chamber 38. The turbulence created in the water as it flows through this water flow path improves operation of reacting salt water with cell plates to create chlorine. While water cascades are a preferred embodiment, a water flow path that creates turbulence such as a serpentine water flow path or the like may be utilized. ORP sensing device 56 is a commonly utilized member for retrieving chlorine and the like for use in commercial pools.

When fluid is removed from the holding chamber by the ORP 56, then this causes the water level and control float 36 to drop to a lower level that triggers float switch 37 to activate inlet valve 42 for water to go to a first mixing chamber 58. Salt drops from salt hopper 44 into first mixing chamber 58. Baffles 52 may be provided in the first mixing chamber for additional mixing effect as the salt falls. The water, salt, and cell plates react to produce chlorine solution. As first mixing chamber 58 fills, the water overflows into a second mixing chamber with another set of cell plates. Thus, the concentration of chlorine increases. The water then overflows into a subsequent mixing chamber and as many chambers as desired, until it reaches holding tank 38 at the desired concentration. The amount of salt released is predetermined to create this concentration. A rotatable salt valve for use as salt hopper valve 46 may be utilized to provide this portioning. As holding tank 38 fills, control float 36 moves up to the point where the water is shut off again by inlet valve 42.

System 30 may be processor-controlled and may use various sensors in place of or with control float 36, rotational salt hopper valve 46, and a flow meter for the water to determine operation. The system may also be mechanically operated with timers and the like. The system can be used with commercial swimming pools, treating sewage, and other industrial use.

For anti-algae purposes to product copper ions, a bar containing copper may be placed above cell plates 40 within the system 30 described above, or within another generator that uses cell plates or produces hydrogen. When hydrogen is produced, it bubbles upwardly in the fluid and encounters the bar, and it reacts with the copper to produce copper ions, which are effective against algae.

In summary of one possible embodiment, water mixes with salt in first mixing chamber 58. This would be activated by float switch 37 that would detect low Cl mixture in the final holding chamber. The mixed brine solution would then travel through the channel chambers where the electrolysis occurs, strengthening the Cl solution as it passes in and out of each celled chamber. Finally, it ends up in the final holding chamber 38 at full desired strength, where it is held and drawn from or pumped from by the ORP sensing device. The float switch 37 may also activate power to the cell plates 40. The brine travels through cell plates 40.

FIG. 4 shows a possible top view with the flow path indicated by flow arrows 50. The cell plates 40 may be of variable length and/or variable length baffles may be utilized with the same size cell plates 40 to produce water cascades 54. FIG. 4 might also be representative of a different system with a serpentine path or with baffles along the flow path thereby stirring the water. Overflow elements may also be used in this possible embodiment of the mixing chamber.

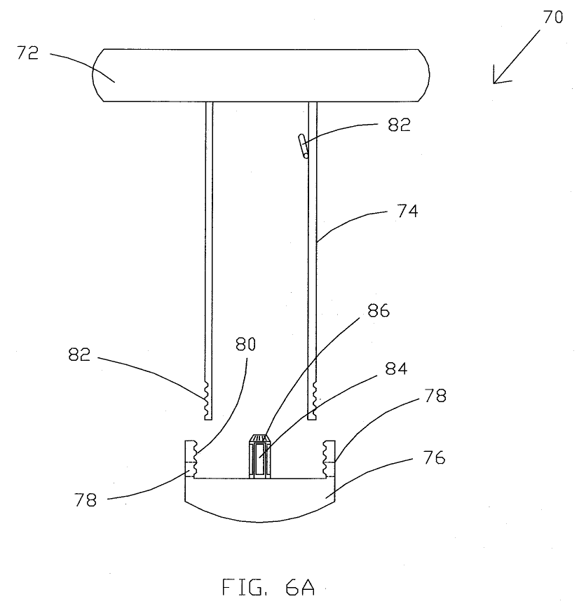

If it is desired to sanitize by producing metallic ions, such as copper or silver ions, then hydrogen bubbles created in this system due to the reaction at the cell plates 40 or other cell plates may be directed to transitional elemental metals such as copper bar 62 or silver or copper/silver alloy as indicated generally in FIG. 5. Various copper, silver, or copper/silver elements such as pellets, powders, or the like may be housed and/or used in place of bar 62. While sanitizing system 30 utilizes cell plates and a hydrogen bubble stream, if desired to utilize KHSO₅ for generating ions or HOCl as discussed above, then the hydrogen stream may or may not be replaced. The ionizing effect on copper, silver, magnesium, and zinc may be produced solely or additionally by the introduction of potassium based compounds. KHSO₅ causes a profound amount of ionic displacement when the copper, silver, or copper/silver anode is placed in a salt brine solution.

In another embodiment of the commercial system of FIG. 3, potassium monopersulfate may be utilized. In this embodiment, salt hopper 44 may be replaced with, or a hopper added, which contains potassium monopersulfate or other potassium compound as discussed above. The cell plates are then no longer necessary. The labyrinth path of mixing chamber 54 may or may not be used.

In one variation of this embodiment, salt hopper 44 is no longer used. The holding chamber 38 will now contain a mixture of potassium monopersulfate, which reacts with salt (NaCl) that may be added to the pool to produce a desired chlorine level in the pool. The salt in the pool may be in the range of about 3,500 ppm, but could be greater or lesser. For instance, the salt brine in “salt” swimming pools may be from about 350 to 500 to 10,000 ppm. In this embodiment, float switch 37 activates a valve, which might replace salt hopper valve 46 for potassium monopersulfate to cause it to drip into the mixing chamber 48. Float switch 37 also activates inlet water valve 42. The mixture then flows to holding tank 38.

In another embodiment, salt hopper 44 could be used with an added potassium monopersulfate hopper. A valve for each hopper would be controlled by the float 36 as discussed above. Both ingredients are added to the mixture chamber 48 to create a chlorine mixture that is stored in the holding chamber. In this embodiment, the cell plates are not necessary due to the reaction of salt, potassium compound, and water that creates chlorine.

In another embodiment, the Potassium Monopersulfate may be liquefied to replace the need for the salt hopper, cell plate chambers, and the like. The liquid KHSO₅ would then drip feed into the mixing chamber when the float switch is activated and the salt would be added to the pool to obtain 3500 ppm. This method would be less cumbersome and cost a lot less to produce. In a preferred embodiment, the potassium monopersulfate is liquefied by mixing it with sufficient distilled water that it is in a suitable liquid form for dripping.

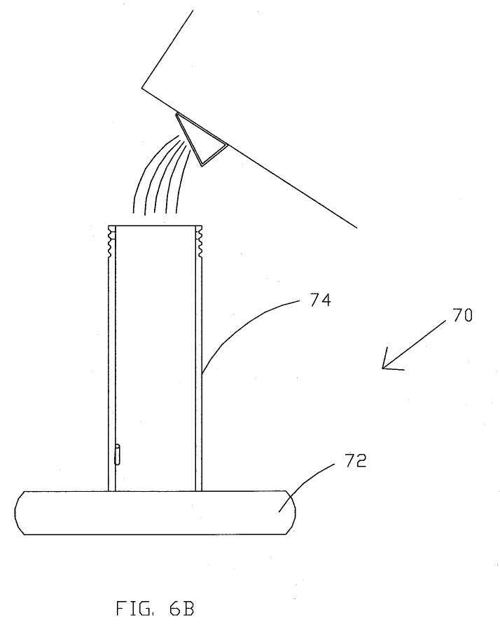

FIG. 6A-8 show various canisters or vessels that may be utilized with swimming pools and pipes and the like for implementing sanitizing reactions as discussed herein.

The following discussing is conveniently described in terms of KHSO₅, H₂O, NaCl, and elemental transitional metals but might also comprise elements that were described previously.

FIG. 6A shows an embodiment of the invention, wherein the reaction of KHSO₅ occurs within a floating canister or vessel 70 and wherein the reaction output may be released to a pool. In this embodiment, canister or vessel 70 comprises float 72, body 74, and removable lower member 76. FIG. 6B shows one possible means for filling canister or vessel 70 such as by unscrewing lower member 76 and filling body 74. Other means for filling canister or vessel 70 may comprise a pre-packaged insert for quick and no-spill insertion designed for insertion into body 74.

In this embodiment, at least KHSO₅ and H₂O and NaCl are input into the canister or vessel. The H₂O is preferably input directly from the body of water through at least one check valve. Sufficient NaCl may already be present in the water for the desired reaction but may also be added to canister or vessel 70 if the concentration of salt in the water is relatively low, e.g. less than about 350 ppm to 500 ppm. As discussed hereinbefore, the resulting reaction produces HOCl for sanitizing the pool. The reaction produces gases such as hydrogen or other gasses that, if desired, may be utilized for delivering the product through flow holes 78. Flow holes 78 may be placed in or near threads 80 or by use of sleeves or other controllable size openings to permit control of the flow rate into the pool. The check valve 82 will allow water and/or salt into canister or vessel 70 whenever the pressure drops below a desired delivery pressure, such that a spring pressure or the like may be used to regulate the delivery pressure and thereby control output. As well, flow holes 78 may be adjustable in size by any of various means. For instance, flow holes 78 near or in threads 80 may align or be blocked due to rotation of the base with respect to the tube whereby mating threads 82 or other portions of body 74 may be used to selectively block or unblock flow holes 78. For example, in FIGS. 6A and 6B, flow holes or slots 78 may be utilized on the threads 80 and/or 82 of either or both lower member 76 whereby rotation to a selectable rotational position controls output. Thus, by any of various control means the canister or vessel will deliver a selectable or pre-set amount of HOCl.

Moreover, canister or vessel 70 may or may not also comprise anode 84 with elemental transitional metal thereon such as copper, silver, zinc, magnesium, and the like, or alloys thereof. Anode 84 may also be constructed to control output such as with a rotatable mount and/or anode sheath 86 or covering whereby fluid access to anode 84 is selectively restricted. Thus, the ion generation control is separate from the control for chlorine or HOCl.

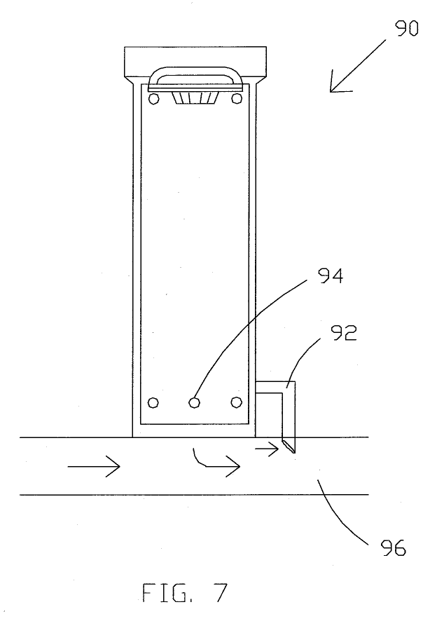

The embodiment of FIG. 7 shows inline canister or vessel 90 whereby shows an adaptation of a canister or vessel of FIG. 6A. Flow line input 92 pulls water out of the pipe and into the canister or vessel from flow line 96. Flow line 96 may be a circulation pipe for a pool or another pipe, which conducts water to be sanitized. Controllable outlet holes or slots 94 may be used control the output for the chlorine level. Holes or slots 94 might have an opening controlled by the relative rotation of sleeves or the like. Other means for controlling output such as valves or the like may also be utilizes. If utilized, an ion generator may comprise a separate control as discussed above. As before, the brine solution may be created with a desired salt concentration within canister or vessel 90 by adding salt and/or may be created with sufficient concentration in the pool and/or in the flow line 96.

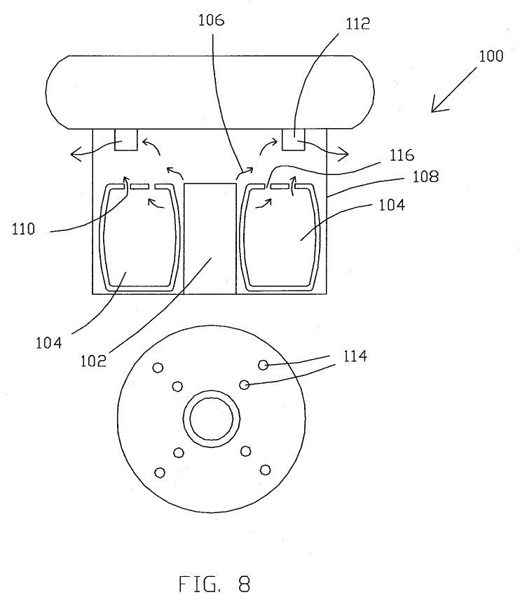

The embodiment of FIG. 8 shows yet another embodiment of the present invention wherein canister or vessel 100 may comprise at least one of cell plates 102 and/or a KHSO₅ reaction chamber(s) 104. The cell plates 102 and reaction chamber(s) 104 may or may not be combined. If combined, the KHSO₅ reaction chamber 104 may be provided as an insertable add on component within body 108, e.g., to super charge chlorine production. In this embodiment, either hydrogen bubbles 106 and/or output 110 from KHSO₅ reaction chamber(s) 104 may contact elemental anodes 112. It will be seen that adjustable holes 114 may selectively aligned by rotation of rotatably mounted adjustment plate 118 with reaction chamber holes 116 to control flow from KHSO₅ reaction chamber(s) 104 Likewise, a rheostat, resistor, or the like, may be utilized to regulate current to the cell plates and therefore the flow of hydrogen bubbles 106. As before, the brine solution may be created with a desired salt concentration within canister or vessel 100, or with an add-on salt holder dispenser, and/or may be created with sufficient concentration in the pool.

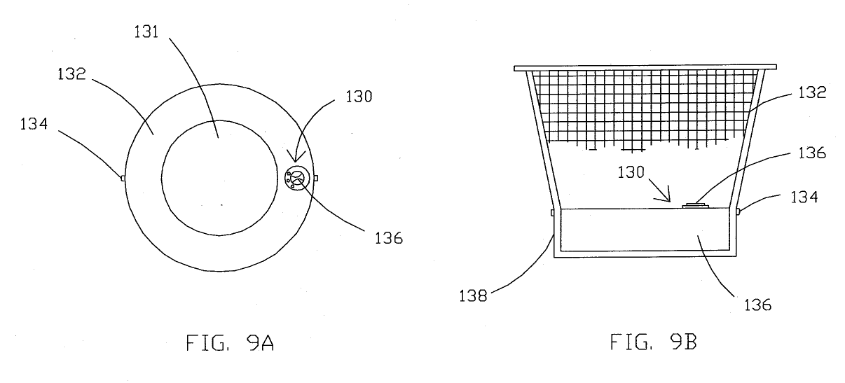

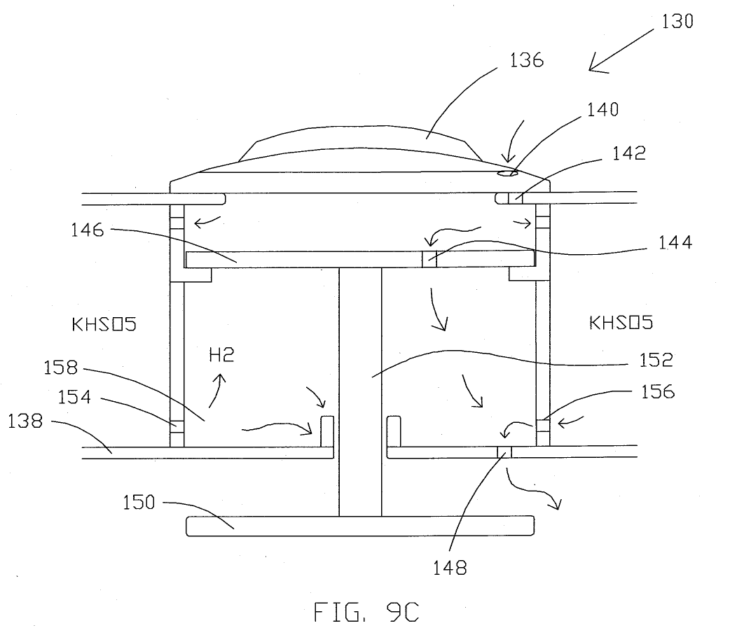

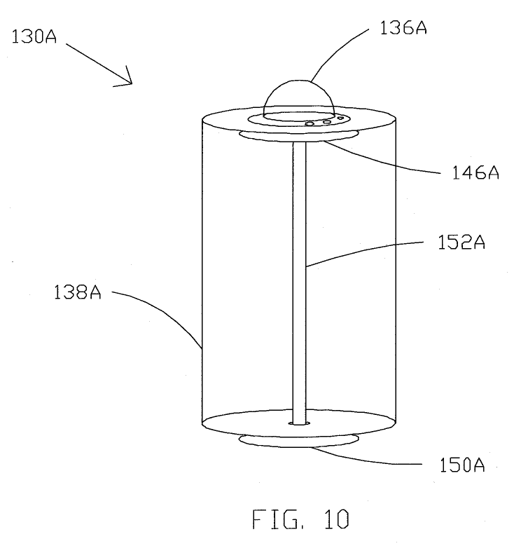

FIG. 9A, FIG. 9B, FIG. 9C show one possible sump pump canister or vessel 130 that may fit into the typical sump of a swimming pool or the like wherein most water flows generally through a tubular center hole 131 in sump debris basket 132 for circulation. Check valve 136 will allow a relatively small amount of water salt water into reaction chamber 146 in body 138 of canister or vessel 130 whenever the pressure drops below a desired delivery pressure. Upper plate or valve member 146 may block input holes 140 and 142 to control water inflow. Likewise lower pate or valve member 150 may block output holes 148. Valve member 146 and 150 and shaft 152 may be lighter than water and therefore be biased closed. A floating member might be used to bias the valve members. Alternative a spring (not shown) mounted around shaft 152, and/or other biasing means may be used to bias valve members 146 and 150 such that a spring pressure floating pressure or the like may be used to regulate the delivery pressure and thereby control output. As well or alternatively, the flow holes may be adjustable in size by any of various means some of which were discussed hereinbefore. For instance, holes near or in the threads may align or be blocked due to rotation of the base with respect to the tube.

Canister or vessel 130 contains KHSO5 and, if necessary, salt to thereby produce sufficient chlorine for sanitation purposes. In one possible embodiment, KHSO5 might be positioned on one side of valve 136 and salt on the other side with mixing holes 154 and 156 permitting flow into a mixing chamber 158. In another possible embodiment the salt and KHSO5 may be combined. In another embodiment, salt may in the water and introduced into canister or vessel 130 along with the water.

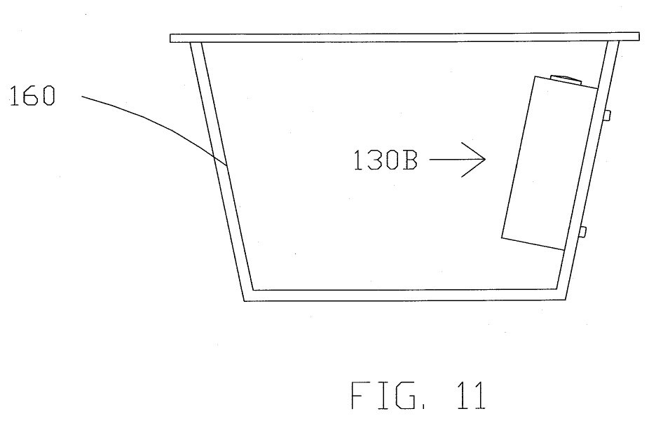

FIG. 10 shows canister or vessel 130A for use in chlorinating a spa. Components of canister or vessel 130A operate similar to corresponding components of canister or vessel 130 discussed above. Thus, body 138A may contain KHSO5 and valve 136A with valve members 146A and 150A may be utilized to control fluid into and out of corresponding flow holes. FIG. 11 shows another possible sump pump canister or vessel 130B which may be similar in operation to canisters 130 and 130A that could be mounted to any sump basket 160 or the like.

The present invention may be utilized for “shocking” a pool. In other words, the present invention may be utilized to achieve breakpoint chlorination. Shocking or breakpoint chlorination refers to the process of adding enough free chlorine molecules to destroy the inorganic chloramines that contribute to combined chlorine levels. Free chlorine may generally have to be added at roughly at least about 10 times the combined chlorine reading to “burn” the chloramines out of the water. The combined chlorine readings may be determined by the difference of free chlorine readings and total chlorine readings. For example, if a pool has 2 ppm total Cl and 1 ppm free Cl=a difference of 1 ppm. Free chlorine or “shock” would have to be added to achieve 10 ppm level of chlorine in the pool water to achieve breakpoint chlorination. In this example, this may require 1.3 lbs. of calcium hypochlorite per 10,000 gallons which, as per the prior art, may be broadcast into the pool using a package of “shock”. With KHSO5 only ¼ that amount would be needed to transform typical salt brine levels of a salt pool to that CL level for the purpose of breakpoint chlorination, i.e., “shocking,” “burn out,” e.g., 4-8 oz. depending on the current salt level in the pool water and the deviation factor between the free available and total chlorine level.

For purposes of the present application, an oxidizer is a substance capable of increasing the number of oxygen atoms or reducing the number of electrons in another chemical. KHSO₅ may be used as an oxidizer in fresh water pools to increase the oxygen molecule to eradicate impurities and used chloramines or used chlorine molecules however when used in fresh water pool the oxidation is not the result of producing Chlorine and/or HOCL as taught herein. When KHSO₅ is applied in the same manner in a salted pool—a large amount of Chlorine and/or HOCL is produced to produce breakpoint chlorination or Shocking. The impurities are then burned out by the high chlorine level as opposed to the oxidation effect that KHSO₅ is intended.

In one possible embodiment, KHSO₅ may be broadcasted (such as by hand or bucket or the like) in a salt pool. Reaching the breakpoint chlorination levels is dependent on the deviation level of the free CL molecule reading and the total CL molecule reading. Thus, as discussed above, typically 1 lb. of shock is used on 10K pool for prior art shocking. KHSO₅ in a salt pool would use approx. 4-5 oz. to achieve breakpoint chlorination. Thus, the present invention provides a very cheap and very effective method for sanitizing

As used herein, sanitize means to make sanitary (as by cleaning or sterilizing) and/or to make more acceptable by removing unpleasant or undesired features such as by removing undesirable chloramines and/or other impurities. Accordingly, sanitizing encompasses shocking or breakpoint chlorination. However, sanitizing also includes the use of reacting KHSO₅ and NaCl in sufficient quantities to produce chlorination ranges as typically used such as from about 0.5 to 3 ppm or other typical ranges of chlorine levels frequently used to keep a pool clean.

Thus, one example of the present invention comprises broadcasting KHSO₅ into a salt water pool that has sufficient NaCL to transform the KHSO₅ and NaCl to the CL level needed for breakpoint chlorination or for at least reaching typically used chlorine levels, e.g., typically in the very approximate range of 4-8 oz. depending on the current salt level in the pool water and the deviation factor between the free available and total chlorine level. Broadcasting includes any means of introducing the KHSO₅ such as by throwing, buckets, handling, dispensing or the like. Testing indicates that 4-5 oz is normally sufficient in a 10K “salt” pool to reach breakpoint chlorination when broadcasted in at one time.

Thus, KHSO₅ may be used as a “Salt Shock” and be prepared in packages or containers sized for this purpose, e.g., the suitable amount for shocking 10,000 gallons of water in a swimming pool. The packages and/or containers may or may not include elemental metals for producing ions as desired, as discussed hereinbefore. The KHSO₅ may be delivered in may different ways such as calibrated packages, inserts or packages that fit into a delivery injector or the like, hand broadcast, or other means for delivery.

In another embodiment, KHSO₅ or (KHSO4 or KHSO3 or other potassium formulations) may be added with CaCL2 (calcium chloride)+NaCL+H2O=to produce chlorine.

If desired, other elemental metals may also be added to the formula. As discussed hereinbefore, this could include all alkaline metals and alkaline earth metals on the periodic table.

In this embodiment, ClO₂ is then be generated. The combination of all three elements (KHSO₅+NaCL+CaCL2) in proportionate amounts makes for a very strong shock that is equal to the brands that are currently stocked and sold by pool chemical supply companies. Some advantages to this mix include lower pricing, better water clarity and decreased time that the swimmers have to stay out of the pool or chlorine spike effect needed to burn out impurities.

As to price, calcium hypochloride shock may sell at this time at $1.07 a lb. in 100 lb buckets. The cost to manufacture this special mix in today's prices is about $0.50 per lb. The combination has other advantages as compared to (CaOCL) besides price. Water clarity is improved, there is less residual in the water, and less wait time for swimmers to reenter the water. It is also safer and easier to handle.

In one possible embodiment, the formula may have a mixture of 33% CaCL/2 (calcium chloride)+33% NaCl (salt)+33% KHSO/5 mixture that produces an effective shock at one 1b per 10,000 gallons of water. These percentages can be modified as desired to enhance or decrease the effectiveness of the shock as needed. Breakpoint chlorination can be achieved by the quantity of mixture added to the water in relation to the free and total chlorine deviation or reading.

This process highlight the effects on CaCL2 as well as NaCL in the oxidation reduction release of the CL molecule. A mixture of elemental metals might be added to this soup to prevent algae growth. The CaCl₂ differs from the CaOCL (calcium hypochloride) in that the chlorine is not present until mixed in water and KHSO₅. This also makes for a stable, non-toxic mixture until it hits the water. This is very important in that there are no special shipping regulations, EPA restrictions, or OSHA restrictions.

In one embodiment, the present invention may comprise reacting at least one potassium based compound with salt in an aqueous solution within a canister or vessel to produce chlorine is a suitable form such as CL, CL/2, CLO/2, HOCl for use in sanitizing said swimming pools, pipes, plumbing, toiletries, waste water, drinking water, and the like, e.g. the potassium compounds+salt+H₂O react to produce chlorine in a suitable form for sanitizing purposes.

This formula may be dispersed into the water or broadcasted out like a normal shock. However, this formula can be placed in the aforementioned and designed mechanisms.

In yet another embodiment, salt pools could benefit from a stain removal method that utilizes KHSO₅ or comparable that when held in a concentrated form and applied to a stain in the pool, will remove the stain. In this way, the consumer will not have to purchase a Cl based product or a small quantity of tabs to achieve the same result.

Another embodiment of the present invention involves phosphate removal. The present invention provides a method in which potassium based salts or compounds are utilized to reduce or remove phosphates in the water by inducing oxygen, which may occur in a saltwater environment or freshwater environment. Delivery methods include but are not limited to broadcasting of the potassium based compounds, liquefied induction, pill or tablet forms.

Another embodiment of the present invention involves bleach production. The present invention provides a method of mixing a proportionate amount of potassium based compound(s) with salt(s) such as but not limited to sodium-based or magnesium-based salt(s), and water for attaining concentrations of chlorine that can be utilized for bleaching and/or sanitation.

For instance, the method may utilize KHSO5 (oxymonopersulfate). As one possible example, 2 gram of KHSO5+2 gram of salt+1 cup water=1 cup of bleach. However, it is understood that other ranges or combinations may also be used. The advantage of this invention is that small amounts may be added to water to produce the desired product. For instance, 2 small pills might be added to a cup of water to produce a cup 1 of bleach at a cost of 0.02 cents. The advantages are more convenient than electrolytic methods of producing bleach as weight, shipping, storage and cost factors are substantially less. Chlorine concentrations may be derived by the mixture of potassium based compounds such as but not restricted to KHSO5, KHSO4, KHSO3 with salts such as but not restricted to NaCl, and water to formulate bleaching compounds or concentrations of bleach for the purpose of sanitation, shocking, and chlorination.

The foregoing disclosure and description of the invention is illustrative and explanatory of presently preferred embodiments of the invention and variations thereof, and it will be appreciated by those skilled in the art, that various changes in the design, organization, order of operation, means of operation, equipment structures and location, methodology, the use of mechanical equivalents, such as different types of fasteners and locking devices than as illustrated whereby different steps may be utilized, as well as in the details of the illustrated construction or combinations of features of the various elements may be made without departing from the spirit of the invention. As well, the drawings are intended to describe the concepts of the invention so that the presently preferred embodiments of the invention will be plainly disclosed to one of skill in the art, but are not intended to be manufacturing level drawings or renditions of final products and may include simplified conceptual views as desired for easier and quicker understanding or explanation of the invention. As well, the relative size and arrangement of the components may be varied from that shown, and the invention would still operate well within the spirit of the invention as described hereinbefore and in the appended claims. Thus, various changes and alternatives may be used that are contained within the spirit of the invention.

Accordingly, the foregoing disclosure and description of the invention is illustrative and explanatory thereof, and it will be appreciated by those skilled in the art, that various changes in the ordering of steps, ranges, interferences, spacings, hardware, and/or attributes and parameters, as well as in the details of the illustrations or combinations of features of the methods and system discussed herein, may be made without departing from the spirit of the invention.

What is claimed is:

1. A method for sanitizing water comprising:
reacting potassium or at least one potassium based compound with a salt in an aqueous solution to produce HOCL for use in sanitizing said water wherein chlorine acts to sanitize said water.

2. The method of claim 1 wherein a sufficient amount of KHSO₅ is utilized within a swimming pool or spa at one time with NaCl and water within said swimming pool to reach breakpoint chlorination levels.

3. The method of claim 2 wherein said KHSO₅ is manually broadcast into said swimming pool or spa.

4. The method of claim 1 wherein KHSO₅ is utilized to at least achieve and/or maintain typical chlorine levels of between about 0.5 ppm to 3.0 ppm chlorine in a swimming pool or a spa.

5. The method of any one of claim 1 further comprising providing packages comprising KHSO₅ in amounts sized for maintaining chlorine levels within a pool or spa or for selectively achieving breakpoint chlorination levels within said pool or spa.

6. The method of claim 5 further comprising inserting said packages into a dispenser for automatic dispensing.

7. The method of claim 1 further comprising substantially continuously delivering said potassium or said at least one potassium based compound to said water using a vessel, whereby a flow is induced in said vessel due to a reaction with a salt within an aqueous solution.

8. The method of claim 7, further comprising interconnecting said vessel with a pipe that carries said water.

9. The method of claim 7 further comprising connecting a flotation device to said vessel.

10. The method of claim 1 further comprising dripping a liquefied potassium based compound into said water at a rate to maintain a selected level of chlorine in said water.

11. The method of claim 10 wherein said liquefied potassium based compound is produced by mixing KHSO₅ and distilled water.

12. The method of claim 10 wherein said rate is controlled by feedback.

13. A method of treating water by generating metallic ions, comprising:
reacting at least one alkali metal and at least one alkali metal salt in H₂O with at least one transitional metal to produce metallic ions of said at least one transitional metal.

14. The method of claim 13 comprising reacting a potassium compound and NaCl in water with said at least one transitional metal to produce said metallic ions.

15. The method of claim 13 further comprising reacting KHSO₅ and NaCl in H₂O with silver or copper or a silver copper alloy to produce silver and/or copper ions.

16. The method of claim 13 wherein said salt water is at least temporarily confined and is then directed to a larger body of said water, which comprises a much lower concentration of salt water.

17. A method for sanitizing water comprising:
reacting at least one potassium based compound with salt in an aqueous solution within a vessel to produce a chlorine in a suitable form comprising at least one of CL, CL/2, CLO/2, or HOCl for use in sanitizing at least one of swimming pools, pipes, plumbing, toiletries, waste water, and drinking water, wherein said at least one potassium compound+salt+H₂O react to produce said chlorine for sanitizing purposes.

18. The method of claim 17 further comprising generating metallic ions from one or more elemental transitional metals by reacting one or more of said elemental transitional metals with said potassium based compound.

19. The method of claim 18 further comprising utilizing separate controls for controlling output of said chlorine and said metallic ions.

20. The method of claim 17 further comprising utilizing pressure build-up from released reactive gasses within said vessel for delivery of chlorine said swimming pools, pipes, plumbing, toiletries, waste water, and drinking water.
